(19) United States
(12) Patent Application Publication
(10) Pub. No.: US 2014/0340520 A1
(43) Pub. Date: Nov. 20, 2014

(54) SYSTEMS AND TOOLS FOR DETECTING RESTRICTED OR HAZARDOUS SUBSTANCES

(71) Applicant: Richard T. Hay, Spring, TX (US)

(72) Inventor: Richard T. Hay, Spring, TX (US)

(73) Assignee: HALLIBURTON ENERGY SERVICES INC., Houston, TX (US)

(21) Appl. No.: 14/344,108

(22) PCT Filed: Sep. 20, 2011
(86) PCT No.: PCT/US2011/052286

§ 371 Date: Mar. 11, 2014

(51) Int. Cl. H04N 7/18

(52) U.S. Cl. CPC H04N 7/183
USPC 348/148

(57) ABSTRACT

Systems and tools for detecting the presence of a substance of interest is presented. The system utilizes a hyperspectral imaging camera to obtain images of an enclosed area, such as a vehicle. Vehicles can include cars, trucks, trains, or boats. The system also includes a processor and storage device. The processor receives the images taken by the hyperspectral imaging camera. Next, the processor determines whether such images contain certain substances. These substances include alcohol, carbon monoxide, illegal substances, and hazardous chemicals. The storage device is electrically coupled to the processor, and is used to store certain data information such as detection events, substance detected, and the time of detection. Such information can be sent over the internet, or streamed live to a laptop at a remote location. The present embodiment can be used by law enforcement to monitor vehicles of interest, and become an important part of public safety.

### BACKGROUND

Monitoring illegal and hazardous substances has always been a priority for government and law enforcement agencies. Alcohol, illicit drugs, explosives, carbon monoxide or other hazardous or restricted substances may be substances of interest. One way to monitor these substances is to perform such monitoring at check points and/or roadblocks, especially in war zones. For example, Driving While Intoxicated (DWI) checkpoints are roadblocks set up by law enforcement agencies on selected roads and highways to stop and detain individuals suspected of driving while intoxicated. Much like a roadblock that is established for border crossings or agricultural checks, officers use a neutral policy in determining when to stop vehicles and check the sobriety of the driver. If the driver appears intoxicated (with slurred speech, glassy eyes, etc.) officers will ask the driver to exit the vehicle and perform field sobriety tests. If the driver is deemed intoxicated, appropriate detention will follow. However, it sometimes difficult to make such observations in a high traffic environment. Furthermore, many hazardous or restricted substances are difficult to detect with normal human senses.

### BRIEF DESCRIPTION OF THE DRAWINGS

A better understanding of the various disclosed system and method embodiments can be obtained when the following detailed description is considered in conjunction with the accompanying drawings, in which:

FIG. 1 shows an illustrative environment in which the detection system can be employed;

FIG. 2 shows an illustrative hyperspectral camera system;

FIG. 3 is a side view of an illustrative image captured by a hyperspectral camera;

FIG. 4 is a spectral graph of an illustrative substance of interest; and

FIG. 5 is a diagram of an illustrative method for detecting substances of interest.

### DETAILED DESCRIPTION

The issues identified in the background are at least in part addressed by the disclosed systems and tools for detecting banned or hazardous substances. At least one disclosed tool embodiment is a hyperspectral imaging camera for detecting the presence of a substance of interest in a vehicle. The camera includes an electronic image sensor that captures spectral images, and a processor electronically coupled to the image sensor. The processor receives the spectral images and determines whether air or surfaces in or on the vehicle includes at least one substance of interest. Illustrative substances of interest include alcohol and carbon monoxide, as well as explosives, illicit drugs, and any other restricted or hazardous chemicals. The vehicles being imaged by the camera can include cars, trucks, trains, boats or other method of transportation.

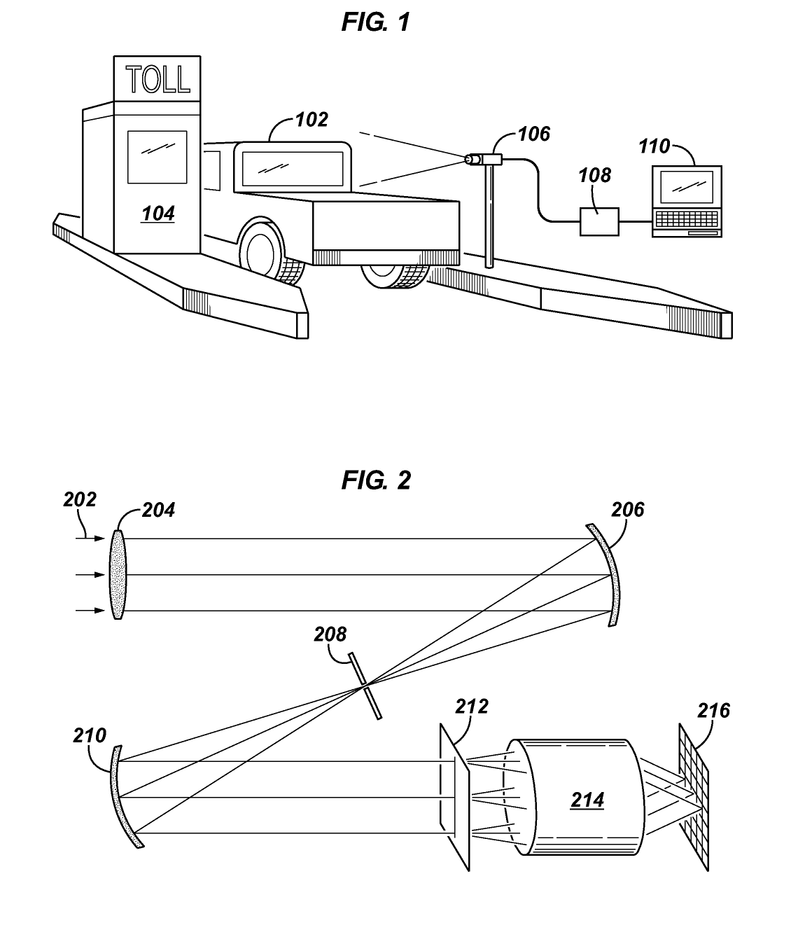

To further assist the reader's understanding of the disclosed systems and methods, we describe an environment suitable for their use and operation. Accordingly, FIG. 1 shows an illustrative detection environment. A vehicle 102 is passing through a toll lane next to a toll booth 104. As the vehicle 102 is passing, a hyperspectral camera 106 captures an image including a view through the vehicle's windshield or through the side window. The camera 106 may be pointed in such a manner as to cover the area where the driver of the vehicle 102 is situated. Vapors in the air of the driver and/or passenger compartment or residue on or in the compartment surfaces, people or other items inside or external, will exhibit a spectral signature that can be captured as part of the spectral image. The camera communicates the spectral image to an information storage device 108, from which it can be accessed by a processor such as that of a programmable computer 110. The processor obtains the spectral images that are taken by the camera 106, and determines whether air in the vehicle includes at least one substance of interest. The results of the computer's analysis can be displayed on a screen, sent over a communications network to a remote location, and/or stored locally for future reference.

Among the persons receiving the results of the computer analysis may be a police officer in the vicinity of the tool booth. Based on the results, the police officer may detain the vehicle to notify the occupants of the suspected presence of restricted or hazardous materials. In some cases the police officer may conduct further investigation of the situation and if warranted may detain the occupants and/or impound the vehicle.

Some system embodiments may include automated signage to notify the vehicle occupants of the analysis results. Such notification may be deemed particularly useful for hazardous substances such as carbon monoxide. The signage may include a phone number for the occupants to obtain additional information along with a message encouraging the occupants to have their vehicles evaluated for safety without undue delay.

FIG. 2 shows an illustrative configuration for a hyperspectral camera 106, representative of a camera manufactured by Rebellion Photonics. Incoming light 202 from the object passes through an entrance aperture 204, which may include a window or lens system of quartz, sapphire, or some other high-optical-bandwidth material. Many such systems are known which can provide variable aperture size, variable focal distance, and variable magnification (i.e., zoom). A focusing mirror 206 focuses light from the aperture onto a first image plane 208 having a slit that passes one “line” from the image at a time. The slit is moved systematically to scan across the image. The current image “line” is collimated by a second mirror 210 that directs the collimated light through a diffraction grating 212. For each point on the current image line, the diffraction grating splits the light into a spectrum in a direction perpendicular to the line orientation, thereby making the spectral information for each point on the line available to a detector (such as a CCD sensor). A processor aggregates this spectral information from each image line to obtain spectral information for each point in a two-dimensional image, thereby forming a hyperspectral snapshot of the scene. A supplemental optics system 214 may be included to align the light to the detector as the slit 208 scans across the image.

The hyperspectral imaging camera uses the power of digital imaging and spectroscopy. Every pixel in the image contains a continuous spectrum (in radiance or reflectance) and can be used to characterize the objects in the scene with great precision and detail. For each pixel in an image, a hyperspectral camera acquires the light intensity (radiance) for a large number of contiguous spectral bands.

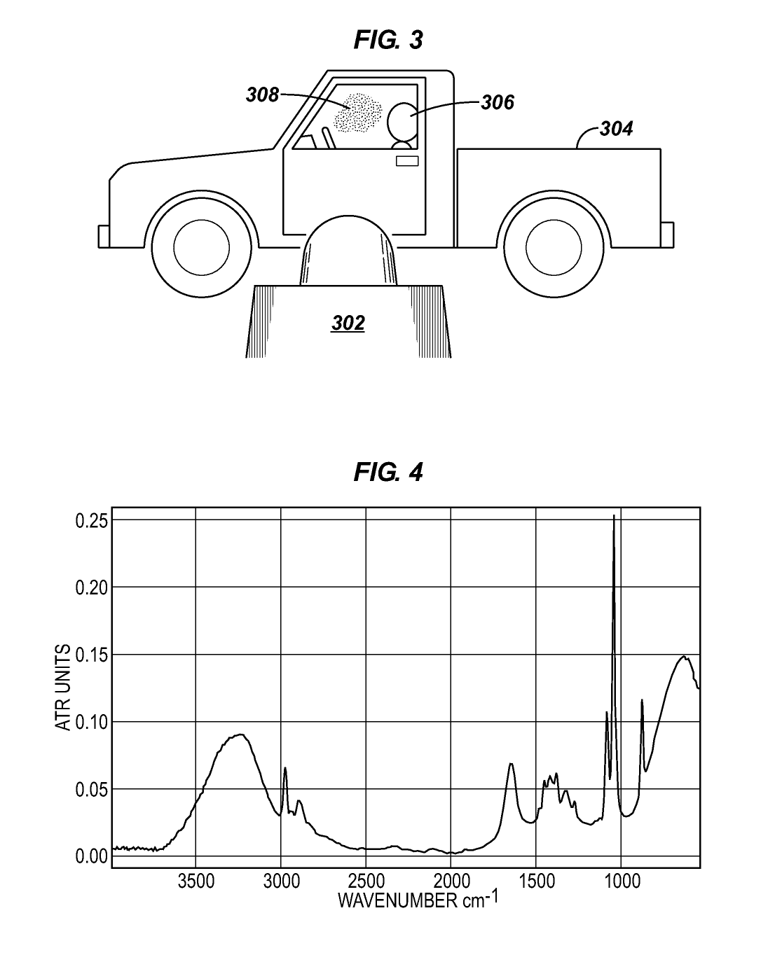

Hyperspectral images provide much more detailed information about the scene than a normal camera. A normal camera would only acquire three different spectral channels corresponding to the visual primary colors red, green and blue. Hyperspectral imaging leads to a vastly improved ability to classify the objects in the scene based on their spectral properties. FIG. 3 shows an illustrative sketch representing a captured image from the hyperspectral camera 302. The sketch in FIG. 3 shows a side view of a vehicle 304, where an individual 306 is driving by a checkpoint. The sketch in FIG. 3 also shows alcohol chemicals 308 in the air inside the vehicle 304, near the individual's 306 mouth area. The processor will collect the image, and process the information across the electromagnetic spectrum. Hyperspectral sensors provide reflectivity information from hundreds of bands including the infrared (IR) range of the electromagnetic spectrum. The scene is illuminated by light sources, and then the reflected light is captured by the hyperspectral sensor. Light sources can include the sun, or some artificial lighting provide at the checkpoint. Lasers, preferably tuned to peak response frequencies of particular substances of interest can be projected through the interior space of the vehicle which excites and enhances the sensitivity of the camera to the presence of those particular substances. A plurality of lasers and/or laser wave lengths can be utilized to enhance the scanning of the interior of the car. Such lasers would be of low emission strength so as not to harm the occupants of the vehicle but strong enough to obtain a desirable response or amplification of the substance being scanned for. The processor collects reflections at various IR and/or near infrared wavelengths and compares the measured spectra against stored templates to determine whether substances of interest are present in the captured image.

FIG. 4 is graph of an illustrative spectral reflectance template for ethanol. Ethanol is the principle constituent for alcoholic beverages, which makes it a substance of interest for law enforcement. When light reflects off materials, it produces a specific spectral signature unique to the chemical composition of that material. The camera captures the spectral signatures of each pixel in its field of view. If the signature is in a database of spectral information for known materials, then a single pixel can provide enough information to identify a substance. The volume and concentration of identified substances can be estimated through the use of image processing to identify discrete areas or volumes (e.g., those areas of the image representing a closed passenger compartment of a vehicle) and combining information from the relevant pixels to measure the average concentration as represented by the intensity of the light attributable to that spectral signature. Besides reflective properties, some embodiments can include a captured image of a substance where absorbed light is measured. This embodiment captures an image with a light source located on the opposite direction of the camera. Thus, the captured image is located between the camera and the light source. Some embodiments can include a camera capable of capturing images without a light source. Other embodiments can capture an image through the use of emitted light. This particular embodiment uses the emission of light through the fluorescence process or radiated light such as heat or infra red light.

Among other things, the camera 106 can scan for gases or particulates of restricted or hazardous substances in the vehicle 102, such as ethyl alcohol (C₂H₅0H), illicit drugs (such as marijuana smoke or cocaine residue on skin surfaces), explosives, or other related chemicals such as nitrates or ionized gases generated by ionizing radiation. Spectral imaging may be useful because there are many chemicals that may be of interest to law enforcement. For example, marijuana can contain over 400 different chemicals, but the main chemical that causes effects is Tetrahydrocannabinol (THC) or dronabinol. The hyperspectral camera 106 can scan for all of these chemicals. Other chemicals can come from hazardous cargo leaks, such as chlorine gas, propane gas, or other harmful gases or substances.

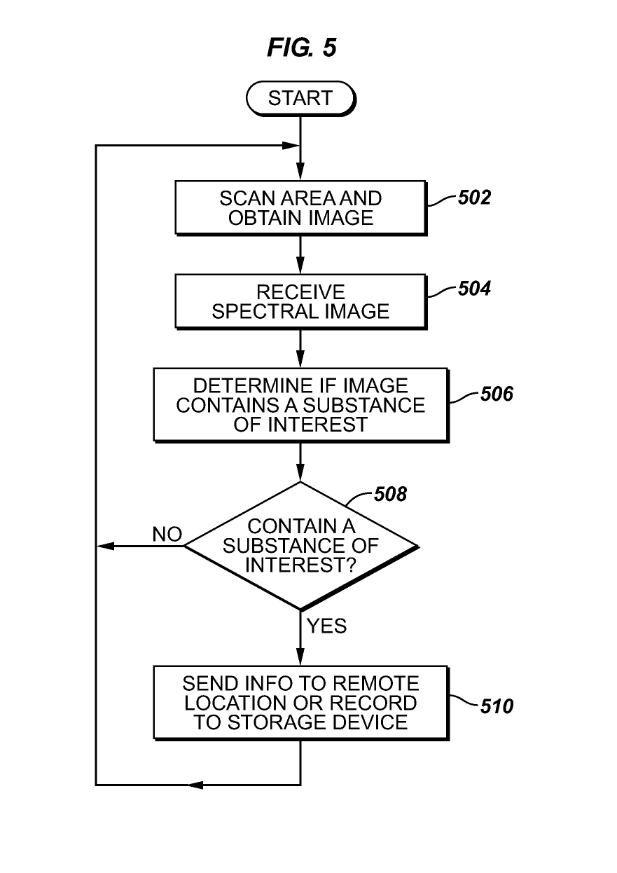

FIG. 5 is an illustrative flow diagram of the method used to detect a substance of interest. In block 502, the area of interest is scanned and an image is taken by the hyperspectral image camera. The area of interest is likely to be a vehicle, which can be a car, truck, train, boat, etc. Next, in block 504, the spectral image is taken by the processor, and analyzed for substances of interest, see block 506. In block 508, a decision is made whether or not the image taken by the hyperspectral camera contains one of the substances of interest. If the image contains a substance of interest, then the detection information is sent to a remote location or the information is stored for later monitoring. If no substance is detected from the current image, the method is repeated for a different object or vehicle.

Another embodiment can come in the form of a portable device much like a radar gun that can be handheld or mounted to a vehicle. A police officer may employ the portable device in much the same manner as a radar gun, directing it at selected vehicles to perform a remote examination for substances of interest and using the results of that examination to determine whether or not the selected vehicle should be detained for further examination. A supervisor on a construction, industrial, or military site could similarly employ the portable device to monitor vehicles entering or exiting the site to ensure safety and/or verify compliance with rules for the site. Short range versions of the portable device may include infrared or UV lamps, while longer-range versions may include laser light sources.

Different embodiments for systems and tools for detecting banned or hazardous substances are presented. At least one embodiment includes a hyperspectral imaging camera for detecting the presence of a substance of interest in a vehicle. The camera includes an electronic image sensor that captures spectral images, and a processor coupled to the hyperspectral image sensor. The processor receives spectral images and determines whether air in the vehicle includes at least one substance of interest. Substances of interest can include alcohol, carbon monoxide, illegal substances, or hazardous chemicals. Vehicles can include a car, truck, train, boat, aircraft taxiing or parked on the ground, or other method of transportation. The processor can also stream information live over the internet to a remote location. Some embodiments may have a process coupled to an imaging multiplexer. The imaging multiplexer includes a periscope on a rotatable swivel that rotates a mirror and a lens to observe more area in the vicinity of the camera. Another embodiment includes a system for monitoring substances of interest within a vehicle. This system embodiment includes a hyperspectral imaging camera that obtains images, a processor, and a storage device. The processor receives the spectral images, and determines whether those images contain substances of interest. The storage device can store events taken by the camera and processor. The storage device can store information such as the detection events, substances detected, and time of detection. The storage device can be located in the vehicle or transmitted via radio or other communications means to another location for analysis, storage and retrieval.

These and other variations and modifications will become apparent to those skilled in the art once the above disclosure is fully appreciated. It is intended that the following claims be interpreted to embrace all such variations and modifications.

What is claimed is:

1. A hyperspectral imaging camera for detecting the presence of a substance of interest in a vehicle, the camera comprising:
an electronic image sensor that captures spectral images; and
a processor electrically coupled to said image sensor to receive said spectral images and determine whether air in the vehicle includes at least one substance of interest.

2. The camera of claim 1, further comprising: an imaging multiplexer coupled to said processor.

3. The camera of claim 2, wherein said imaging multiplexer, further comprises: a periscope on a rotatable swivel that rotates a mirror and a lens to observe more area in the vicinity of the camera.

4. The camera of claim 1, wherein a vehicle is a transportation method, such as a car, truck, train or boat.

5. The camera of claim 1, wherein said imaging camera is able to capture passing vehicles.

6. The camera of claim 1, wherein said imaging sensor obtain images from a moving object.

7. The camera of claim 1, wherein said processor divides said images into multiple bands across an electromagnetic spectrum.

8. The camera of claim 1, wherein said substance of interest is alcohol, carbon monoxide, illegal substances, and hazardous chemicals.

9. The camera of claim 1, wherein said imaging camera is used to scan hazardous cargo for leaks, such as chlorine gas, propane gas, or other harmful gases.

10. The camera of claim 1, wherein said processor determines and recognizes substances from a captured image.

11. The camera of claim 1, wherein said processor sends information over the internet to a remote location.

12. The camera of claim 1, wherein said processor streams information live to a remote location.

13. A system for monitoring substances of interest within a vehicle, the system comprising:
a hyperspectral imaging camera that obtains images of an interior of the vehicle;
a processor electrically coupled to said imaging camera, wherein said processor receives said images and determines whether said images contain substances of interest; and
a storage device electronically coupled to said processor.

14. The system of claim 13, wherein said vehicle is a transportation method, such as a car, truck, train or boat.

15. The system of claim 13, wherein said imaging camera is set up to monitor passing vehicles.

16. The system of claim 13, wherein said imaging camera obtains images from moving objects.

17. The system of claim 13, wherein said processor divides said images into multiple bands across an electromagnetic spectrum.

18. The system of claim 13, wherein said imaging camera includes an imaging multiplexer, such as a periscope on a rotatable swivel that rotates a mirror and a lens to observe more area in the vicinity of the camera.

19. The system of claim 13, wherein said substance of interest is alcohol, carbon monoxide, illegal substances, and hazardous chemicals.

20. The system of claim 13, wherein said imaging camera is used to scan hazardous cargo for leaks, such as chlorine gas, propane gas, or other harmful gases.

21. The system of claim 13, wherein said processor determines and recognizes substances from a captured image.

22. The system of claim 13, wherein said processor sends information over the internet to a remote location.

23. The system of claim 13, wherein said processor streams information live to a remote location.

24. The system of claim 13, wherein said storage device store information, such as detection events, substances detected, and the time of detection.
